(19) United States
(12) Patent Application Publication
(10) Pub. No.: US 2020/0262755 A1
(43) Pub. Date: Aug. 20, 2020

(54) DURABLE CONCRETE WITH CHEMICALLY LINKED CEMENT

(71) Applicant: PALO ALTO RESEARCH CENTER INCORPORATED, Palo Alto, CA (US)

(72) Inventors: Gabriel Iftime, Newark, CA (US); Junhua Wei, Mountain View, CA (US); Divyaraj Desai, Fremont, CA (US); Jessica Louis Baker Rivest, Palo Alto, CA (US)

(21) Appl. No.: 16/710,246

(22) Filed: Dec. 11, 2019

Related U.S. Application Data
(60) Provisional application No. 62/806,525, filed on Feb. 15, 2019.

(51) Int. Cl. C04B 24/28; C04B 7/02; C04B 24/12; C04B 24/32; C04B 14/06

(52) U.S. Cl. CPC C04B 24/281; C04B 7/02; E01C 11/005; C04B 24/32; C04B 14/06; C04B 24/121

(57) ABSTRACT

A composition of matter has cement particles and resin structures having: a first functional group bonded directly to a surface of each cement particle; and a second functional group that bonds to calcium silicate hydrate upon hydration, wherein the second functional group is bondable with second functional groups of others of the cement particles to form a polymer network; and a backbone that connects the first functional group with the second functional group. A method of forming cement particles includes mixing cement particles with reactive molecules, the reactive molecules having a first functional group bonded directly to a surface of each cement particle, a second functional group that is bondable to calcium silicate hydrate upon hydration, wherein the second functional group is bondable with second function groups of others of the cement particles to form a polymer network, and a backbone that connects the first functional group with the second functional group. A composition of matter has cement particles, and a cured resin structure resulting from a reaction between two or more reactive molecules having functional groups that react with each other onto the surfaces of the cement particle, wherein one of the reactive molecules is used in less than a stoichiometric amount, leaving unreacted functional groups, and wherein the unreacted functional groups are bondable to calcium silicate hydrate upon hydration.

### CROSS REFERENCE TO RELATED APPLICATION

This application claims priority to and the benefit of U.S. Provisional Application No. 62/806,525 filed Feb. 15, 2019, which is incorporated herein by reference in its entirety.

### TECHNICAL FIELD

This disclosure relates to cement, more particularly to cement particle architecture.

### BACKGROUND

The United States National Highway System includes a total of 2.6 million miles of paved roads, of which 230,000 miles is Interstate Highways, major roads and over 610,000 bridges. To meet demands for increased construction rates, modern infrastructure is built with fast-setting or early strength concrete that incorporate large amounts of tricalcium silicate (C₃S). Current cement used in current concretes suffers from brittleness and issues with permeability to salts and water. The effective service life lasts approximately 50 years.

Unfortunately, modern infrastructure deteriorates at alarmingly faster than designed rates. They require accelerated repair and replacement schedules. This increases the life-cycle costs and emissions associated with manufacturing more concrete. A range of potential solutions for the durability problem have been investigated, but so far, none has been commercially deployed. They have been challenged either by high costs, limited availability of materials.

Consequently, there is currently no commercially mature technology that can produce concrete with a designed life service >100 years, with fast setting capability and a with a life-cycle cost-parity with conventional modern concrete.

### BRIEF DESCRIPTION OF THE DRAWINGS

FIG. 1 shows prior art cement particles in water before cement hydration

FIG. 2 shows an embodiment of cement particles with functionalized groups in water before cement hydration.

FIGS. 3 and 4 compare cement hydration processes in prior art cement particles with cement particles having functionalized surfaces that form a polymer network when cement particles react with water to produce cured or hydrated cement

FIG. 5 shows cement particles with functionalized surfaces.

FIG. 6 shows a polymer network in a hydrated cement product.

FIG. 7 shows an embodiment of suitable reactive molecules.

FIGS. 8-9 show examples of the functional groups on cement particles to form a polymer network.

FIGS. 10-12 show the results of a water-absorbing epoxy and its use in a concrete mix.

### DETAILED DESCRIPTION OF THE EMBODIMENTS

Embodiments here disclose a novel architected high-performance cement based on a new cement particle architecture, wherein the surface of the cement particle is chemically functionalized with water-miscible reactive functional groups. Cement, as that term is used here, is typically a powdery substance made with calcined lime and clay. Mortar is formed when the cement is mixed with water and sand. Concrete is formed when the cement is mixed with sand, water, gravel, and optional components such fly ash, and slag. Cement hydration occurs when the cement is mixed with water and the cement becomes bondable.

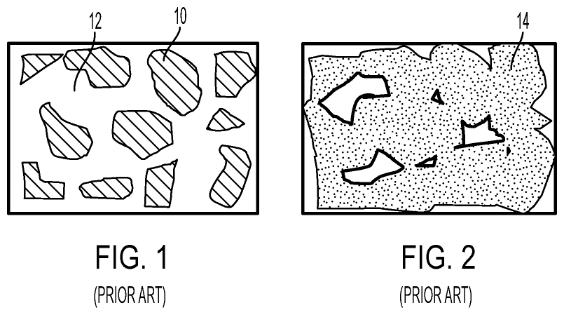

FIGS. 1-2 and 3-4 show current versions of cement and an example of the embodiments here, before and after cement hydration. Current cement particles 10 in water 12, shown in FIG. 1, form a cured cement 14 shown in FIG. 2 that is too brittle and too permeable to salts and water. As a result, its service life is ˜50 years.

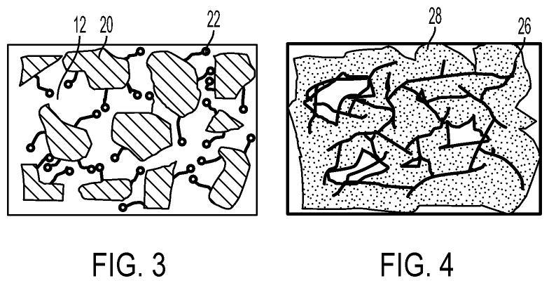

In the embodiments here, upon cement hydration, the functional groups 22 from FIG. 3 bond to the hydroxyl reactive sites of the cement hydrate 28 in water 12 to produce a cured cement, shown in FIG. 4. The cured cement incorporates cross-linked polymer networks molecularly dispersed within, and chemically bonded to, the hydrated cement. The cement of the embodiments such as that shown in FIG. 3, with water-miscible functional groups 22 on the surfaces of the particles 20, has clear advantages including outstanding resistance to permeation of water and harmful sulfates and salts, toughness, and long-term self-healing ability. It will increase service life of concrete bridges to over 180 years.

FIG. 2 shows a prior art example of cement hydrate 24 without any functional groups. FIG. 4, in contrast, the cement particles 28 have functionalized groups that bond to each other to form a much stronger, flexible and water blocking polymer network 26.

The embodiments include a novel cement particle architecture with water-miscible reactive resin molecules bonded onto the surface of cement particles. After mixing these functionalized cement particles with water and the other concrete components, the resin curing takes place in tandem with the cement hydration.

Ready mix concrete can be manufactured by replacing conventional cement particles with these novel cement particles.

The presence of functional curable groups onto the surface of the cement particles and the resin's compatibility with water are crucial requirements. They create a cement hydrate structure that incorporates uniformly distributed cross-linked chemically linked polymer networks that are molecularly dispersed within the calcium silicate hydrate (CSH) structure of either hydrated cement, cured cement, or concrete, depending on formulation.

The embodiments of the particle architecture remove the limitations encountered with polymer admixtures in four major ways. First, it minimizes water permeation by eliminating the inhomogeneities associated with phase-separated polymer macro/micro domains. Second, it eliminates leaching by crosslinking and chemical bonding to the CSH structure. Third, it increases the toughness without affecting strength, enabled by the energy absorbing capability of the ductile polymer network to the CSH structure. Fourth, it has long-term self-healing ability enabled by slow water release for complete cement hydration

As a general methodology, the novel architected cement particles are fabricated by attaching suitable reactive molecules onto the surface of conventional cement particles. With respect to the method for producing functionalized cement particles, in order to obtain uniformly functionalized cement particles, the attachment is carried out by mixing the suitable reactive molecules and conventional cement powders. Depending on the chemical functions that attach onto the surface of the particles, heating and curing initiators may be required.

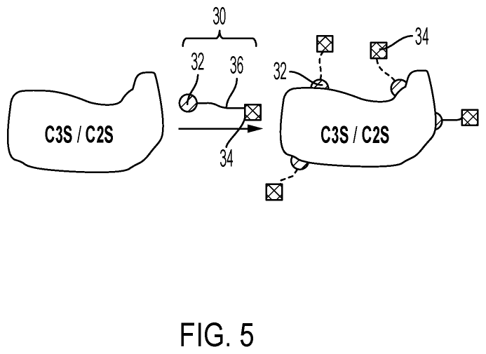

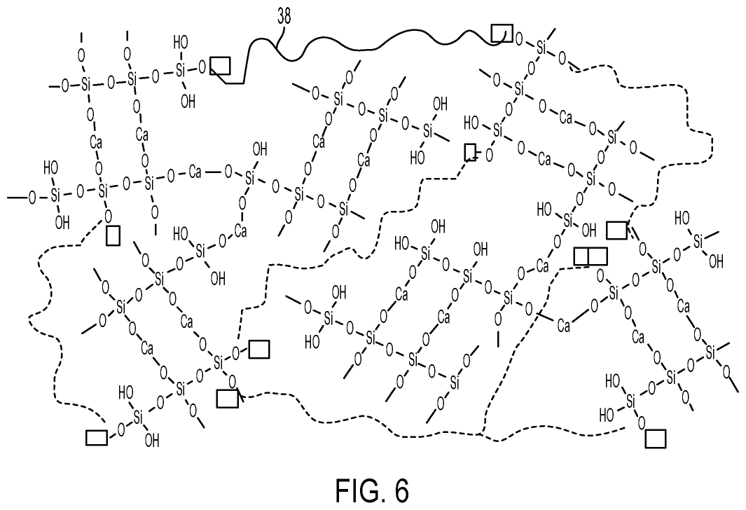

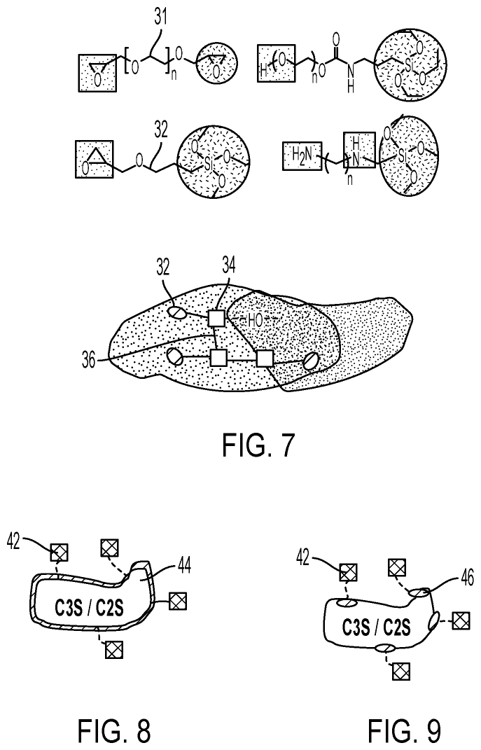

In a first embodiment, the reactive molecules consist of a single small molecule or polymer, as shown in FIG. 5, with a structure 30 having a first functional group 32 which bonds onto the surface of the cement particles, a second functional group 34 which bonds to CSH upon hydration, by interaction with the hydroxyl groups present into CSH, and a backbone 36 that connects the first functional group 32 with the second functional group 34. The backbone 36 is miscible with water. This creates, in the cured cement, a CSH structure incorporating a network of flexible water swelling polymer chains, shown in FIG. 6 as 38. Epoxy and trialkoxysilanes, shown in FIG. 7 as circles, have been identified as the leading options for chemical attachment of the resin onto particles. Chemical bonding to the cured cement results from reacting the second functional group, shown as squares, with hydroxy functions that are created in CSH during hydration. Bonding to the cured cement can be through direct covalent bonding, for example when the second functional group is epoxy, or by physical bonding, such as by hydrogen bonding, for example when the second functional group is hydroxyl (—OH) or amino (—NH2; —NHR).

Water miscible backbones 36 include polyethylene-oxide, polyamines, polyethylene glycol or other water miscible backbones.

As an example, to illustrate the selection criteria for suitable reactive molecules, in the molecule labeled 31 in FIG. 7, the first functional group is an epoxy, the second group is also an epoxy and the backbone bonding the two functional group is polyethylene oxide. For the molecule labeled 33, the first group is trimethoxysilane, the second group is epoxy and the backbone is polyethylene oxide.

For example, in the case when the first functional group is an epoxy, the chemical bonding of the epoxy onto the surface of the particles is achieved by heating while mixing. The temperature is generally in a range from 50° C. to about 150° C. Generally, the reaction requires same amount of base as a catalyst. If the reaction is performed in air, then there is sufficient humidity to partially hydrate a small fraction of the cement. This produces small amounts of Ca(OH)₂ that are sufficient to catalyze the process. In more dry environments, a small amount of Ca(OH)2 may be added.

In the case where the first functional group is trialkoxysilanes, generally the reaction requires small amounts of water, which can be supplied as vapors during functionalization of the cement particle. It is understood that this will create some hydrated areas onto the surface of the cement particle, but most of the cement particle will be unaffected by hydration at this stage.

In a second embodiment, the reactive molecules consist of two or more reactive molecules or polymers, which react with each other during the fabrication of architected cement particle. A particularly suitable example of this embodiment is represented by 2-part epoxy reactive molecules system consisting of an epoxy resin and a hardener.

Functionalization is achieved by treating the surface of cement particles with a mixture of an epoxy resin plus a hardener, such as a multifunctional amine as an example, which is preferably water miscible at least to some degree. In order for the particles to be terminated with a reactive group, a deficit of one of the two components is recommended. Then the surface is terminated with these reactive groups. For example, in order to produce epoxy terminated cement particles, a deficit of amine hardener is used. Upon completion of the reaction between the epoxy groups and the hardener, the unreacted epoxy groups present onto the surface of the cement particle are available for reaction with the hydroxyl groups from the CSH upon hydration and produce the polymer network. Alternatively, amino terminated particles are produced when using a deficit of epoxy resin. Deficit is defined as an amount of reagent that is less than the stoichiometric amount required for fully curing a 2-part system epoxy.

With these 2-part epoxy resins, one can expect two possible structures for the functionalized particles, both possessing secondary reactive groups. As shown in FIGS. 8-9, the first structure consists of polymerized resin 44 bonded onto the surface of the particles ended with reactive epoxy groups shown in FIG. 8. The second consists of chemically attached epoxy resins such as 46 covering only partially the surface of the cement particles, as shown in FIG. 9. Various degrees of particle surface coverage, in between these two ranges are possible.

The amount of attached reactive molecules onto the surface of the cement particles is generally comprised within a range from about 0.1% to about 50%. An increased amount of reactive molecules onto the surface of cement particles produces a hydrated cement with increased flexibility and toughness.

The proposed approach of the embodiments is general in the sense that it reduces the permeation and increases the toughness of any concrete mixture to which it is applied. One can create amino reactive elements, terminated with amino groups if amino hardener was in excess, or with epoxy hardener, if the epoxy was in excess.

The embodiments reduce the permeation and increases the toughness of any concrete mixture to which it is applied.

### Example 1

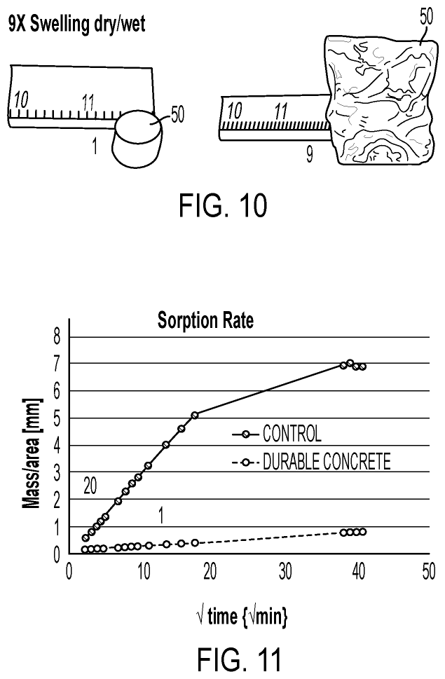

Example 1 shows a reversibly water-absorbing epoxy gel in conditions that are compatible with cement hydration. A mixture of water-soluble epoxy resin was cured in water with a base initiator, such as Ca(OH)₂, NaOH, or other suitable base. This produced a solid wet gel. As can be seen in FIG. 10, the resulting water-absorbing epoxy gel 50 shown in the left side, swells as shown in the right side. Swelling in water is a key enabler for reduction of permeability of water and salts.

### Example 2

Next the process demonstrated the benefits of the in-the-cement cured water-miscible resin. An early-stage mixture was fabricated by mixing a ratio of Portland cement:sand=1:3 and w/cm=0.65 and 10% (w/w to cement) water-soluble resin. The sample was cured for a total of 7 days. A control sample, without resin was fabricated and cured in the same conditions. The test sample showed a reduction of the water permeability, as the sorption coefficient on FIG. 11, by 20× when compared with the control. A difference between the experiments and prior art (<3.5× reduction) is the water-soluble resin which has better dispersability in the water/cement structure. Permeability of NaCl was reduced by 3.3×. Flexural strength (a measure of toughness) increased by 50% simultaneously with the compressive strength.

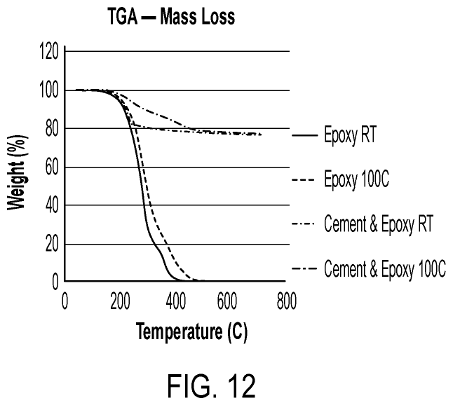

A preliminary demonstration of resin-functionalized cement particles was performed. A result of a thermal gravimetric analysis (TGA) shown is that the test sample (cement+epoxy @ 100° C.) lost mass at a much lower rate than control samples in conditions where the epoxy resin does not cure, as shown in FIG. 12.

In this manner, cement particles are created that minimize water permeation, eliminates leaching, increase the toughness of the resulting material using the cement without affecting its strength, has long-term self-healing ability. The embodiments include cement particles having functionalized surfaces. The functionalization with epoxy resin may be activated by a base such as NaOH or Ca(OH)₂. The functionalization may be with epoxy resin plus a hardener mixture. Embodiments include cured concrete with the cement particles having functionalized surfaces. The embodiments may include other types of materials that use the cement particles with functionalized surface including mortars and ceramics.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the below claims.

What is claimed is:

1. A composition of matter, comprising:
cement particles; and
resin structures having:
a first functional group bonded directly to a surface of each cement particle; and
a second functional group that bonds to calcium silicate hydrate upon hydration, wherein the second functional group is bondable with second functional groups of others of the cement particles to form a polymer network; and
a backbone that connects the first functional group with the second functional group.

2. The composition of matter as claimed in claim 1, further comprising sand and water to form mortar.

3. The composition of matter as claimed in claim 1, further comprising at least sand, water, and gravel to form concrete.

4. The composition of matter as claimed in claim 3, wherein the concrete has a permeation rate for water and sodium chloride solution lower than of a concrete made with conventional cement particles.

5. The composition of matter as claimed in claim 1, wherein the first functionalized group comprises one of an epoxy or a trialkoxysilane.

6. The composition of matter as claimed in claim 1, wherein the second functionalized group comprises one of an epoxy, hydroxy or amino groups.

7. The composition of matter as claimed in claim 1, wherein a surface of the cement particle is covered partially with the resin structure after the resin structure is cured.

8. The composition of matter as claimed in claim 1, wherein the backbone consists of one of either polyehthylene-oxide or polyamines.

9. The composition of matter as claimed in claim 7, wherein the amount of the resin cured onto the surface of the particle is in a range from 0.1% to 50%.

10. A method of forming cement particles, comprising:
mixing cement particles with reactive molecules having:
a first functional group bonded directly to a surface of each cement particle; and
a second functional group that is bondable to calcium silicate hydrate upon hydration, wherein the second functional group is bondable with second function groups of others of the cement particles to form a polymer network; and
a backbone that connects the first functional group with the second functional group.

11. The method as claimed in claim 10, further including one of heating or adding water vapors during mixing.

12. The method as claimed in claim 10, wherein the first functional group is an epoxy and a base is added as a catalyst.

13. The method as claimed in claim 10, wherein the reactive molecules are present on the surface of the particle in an amount of 0.1% to 50%.

14. A composition of matter, comprising:
cement particles; and
a cured resin structure resulting from a reaction between two or more reactive molecules having functional groups that react with each other onto surfaces of the cement particle, wherein one of the reactive molecules is used in less than a stoichiometric amount, leaving unreacted functional groups, wherein
the unreacted functional groups are bondable to calcium silicate hydrate upon hydration.

15. The composition of matter of claim 14, wherein the two or more reactive molecules include an epoxy resin and an amino hardener

16. The composition of matter of claim 14, wherein at least one of the epoxy or hardener components is soluble in water.

17. The composition of matter of claim 14, wherein the amount of the cured resin onto the surface of the particle in comprised in a range from 0.1% to 50%.

18. The composition of matter of claim 14, wherein a surface of the cement particle is covered partially with the cured resin structure.

19. The composition of matter as claimed in claim 14, further comprising sand and water to form mortar.

20. The composition of matter as claimed in claim 14, further comprising at least sand, water, and gravel to form concrete.
